(19) United States
(12) Patent Application Publication
(10) Pub. No.: US 2018/0301949 A1
(43) Pub. Date: Oct. 18, 2018

(54) HUB MOTOR

(71) Applicant: CHINA DRIVE MOTORS (SHENZHEN) CO., LTD., Guangdong (CN)

(72) Inventors: Pingxian ZHONG, Guangdong (CN); Junfeng LIU, Guangdong (CN)

(73) Assignee: CHINA DRIVE MOTORS (SHENZHEN) CO., LTD., Guangdong (CN)

(21) Appl. No.: 15/646,098

(22) Filed: Jul. 11, 2017

(30) Foreign Application Priority Data
Apr. 14, 2017 (CN) 201720391471.9

(51) Int. Cl. H02K 1/28; H02K 15/02

(52) U.S. Cl. CPC H02K 1/28; H02K 15/02

(57) ABSTRACT

A hub motor including a hub and an annular tread sleeved on the hub is provided. The tread is fixedly connected to the hub. A plurality of positioning ribs is axially disposed on the outer surface of the hub. Grooves adapted to the shapes of the positioning ribs are formed on the inner surface of the tread, and the positioning ribs are clamped in the grooves. The hub and the tread are separately disposed, a plurality of positioning ribs is axially disposed on the outer surface of the hub, the grooves adapted to the shapes of the positioning ribs are formed on the inner surface of the tread, the positioning ribs are clamped in the grooves, and the tread and the hub are respectively radially convex and concave structures capable of preventing the tread from falling off radially. In this way, the tread of the hub motor are replaceable, the installation structure is simple and firm, and the consumption and cost are greatly reduced.

### CROSS-REFERENCE TO RELATED APPLICATION

This application claims the priority benefit of China application serial no. 201720391471.9, filed on Apr. 14, 2017. The entirety of the above-mentioned patent application is hereby incorporated by reference herein and made a part of this specification.

### BACKGROUND OF THE INVENTION

### Technical Field

The utility model relates to the technical field of motors, in particular to a hub motor.

### Description of Related Art

For existing hub motors, treads are directly molded with hubs through injection, and after the treads are worn out, the entire motors or outer hubs and inner magnetic sheets are required to be replaced, causing difficulties in replacement by user and high cost.

### BRIEF SUMMARY OF THE INVENTION

The main objective of the utility model is to provide a hub motor of which the tread can be replaced, thus reducing cost.

To achieve the above objective, the utility model is implemented in the following way. The utility model provides a hub motor, including a hub and an annular tread sleeved on the hub; the tread is fixedly connected to the hub; a plurality of positioning ribs is axially disposed on the outer surface of the hub; grooves adapted to the shapes of the positioning ribs are formed on the inner surface of the tread; and the positioning ribs are clamped in the grooves.

A further technical solution of the utility model is that, the cross sections of the positioning ribs are sector-shaped to prevent the tread from sliding radially, and the length of an end of each one of the sector-shaped positioning ribs that is away from the hub is greater than the length of an end of each one of the sector-shaped positioning ribs that is close to the hub.

A further technical solution of the utility model is that, the positioning ribs have draft angles.

A further technical solution of the utility model is that, the hub motor also includes a bottom cover disposed at a lateral end of the hub; the tread positioned at a lateral end of the top cover is provided with an annular block piece; after the tread is sleeved on the hub, the bottom cover is fixedly connected to a lateral end of the hub and holds the block piece of the tread to prevent the tread from sliding axially.

A further technical solution of the utility model is that, the bottom cover is fixedly connected to the lateral end of the hub through screws, and the bottom cover and the lateral end of the hub are correspondingly formed with mounting holes of screws.

The utility model has the following beneficial effects: Compared with the structures of the traditional hub motors, the hub and the tread of the hub motor are disposed in a separate way; a plurality of the positioning ribs are axially disposed on the outer surface of the hub; the grooves adapted to the shapes of the positioning ribs are formed on the inner surface of the tread; the positioning ribs are clamped in the grooves; the tread and the hub are respectively radially convex and concave structures to prevent the tread from falling off radially. In this way, the tread of the hub motor provided by the utility model can be replaced; the installation structure is simple and firm, and the consumption and cost are greatly reduced.

### BRIEF DESCRIPTION OF THE SEVERAL VIEWS OF THE DRAWINGS

FIG. 1 is an exploded structural view of a hub motor of the utility model;

FIG. 2 is a lateral view of a hub of the utility model.

To make the objective, technical solution and advantages of the utility model clearer, the utility model is described in further detail in conjunction with the following attached drawings and embodiments.

Description of the marks in the drawings: 1—hub; 2—tread; 3—bottom cover; 4—screw; 5—positioning rib.

### DETAILED DESCRIPTION OF THE INVENTION

It should be understood that the embodiments depicted here are only illustrative, and do not limit the utility model.

The utility model employs the following solution: A hub and a tread of a hub motor are disposed in a separate way such that the tread of the hub motor can be replaced, the hub motor has a simple and firm installation structure, and the consumption and cost are greatly reduced.

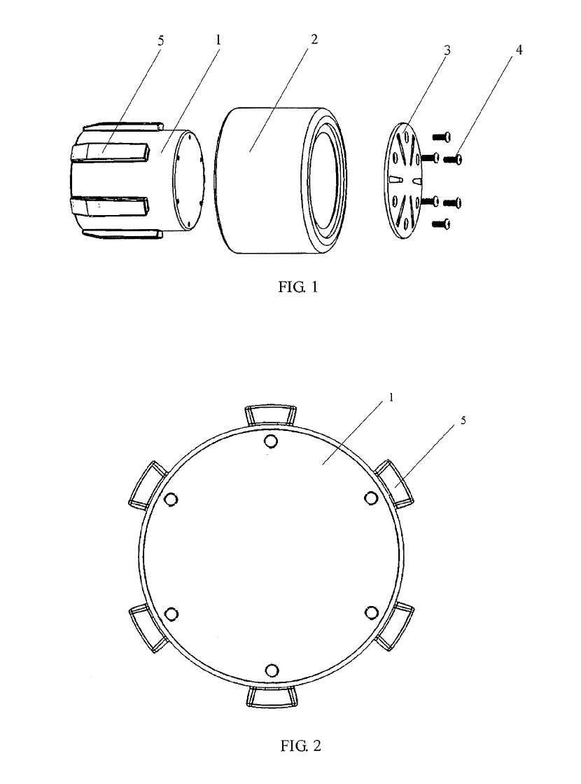

Specifically, refer to FIG. 1 and FIG. 2. The utility model provides a hub motor, including a hub 1 and an annular tread 2 sleeved on the hub 1; the tread 2 is fixedly connected to the hub 1; a plurality of positioning ribs 5 are axially disposed on the outer surface of the hub 1; grooves adapted to the shapes of the positioning ribs 5 are formed on the inner surface of the tread 2; and the positioning ribs 5 are clamped in the grooves.

By the configuration that the hub 1 and the tread 2 of the hub motor are disposed in a separate way, the plurality of positioning ribs 5 are axially disposed on the outer surface of the hub 1, the grooves adapted to the shapes of the positioning ribs 5 are formed on the inner surface of the tread 2, and the positioning ribs 5 are clamped in the grooves, the tread 2 and the hub 1 are respectively radially convex and concave structures, capable of preventing the tread 2 from falling off radially. In this way, the tread 2 of the hub motor provided by the utility model can be replaced; the installation structure is simple and firm, and the consumption and cost are greatly reduced. Specifically, in order to better install and fix the tread 2, in this embodiment, the plurality of positioning ribs 5 are axially disposed at intervals on the outer surface of the hub 1; the grooves adapted to the shapes of the positioning ribs 5 are formed on the inner surface of the tread 2; and the positioning ribs 5 are clamped in the grooves. Wherein, the length of the positioning ribs 5 ensures that the positions ribs can partly or completely cover the hub 1 in the axial direction.

During installation, the tread 2 is sleeved on the rub 1 from one end of the hub 1; the positioning ribs 5 axially disposed at intervals on the outer surface of the hub 1 are matched with the grooves on the inner surface of the tread 2; and thus, the tread 2 is fixed on the hub 1.

Besides, in order to facilitate installation of the tread 2, the surfaces of the positioning ribs 5 at one end of the hub 1 can be configured as inclined wedged surfaces and the positioning ribs 5 are configured to have draft angles.

Further, in order to better position and install the tread 2, the cross sections of the positioning ribs 5 can be sector-shaped, and the length of an end of each one of the sector-shaped positioning ribs 5 that is away from the hub 1 is greater than the length of an end of each one of the sector-shaped positioning ribs 5 that is close to the hub 1, which means that the sector-shaped positioning ribs 5 are tooth shaped and radially enlarge from the inside to the outside. Thus, the radial sliding or falling of the tread 2 can be effectively prevented, and the tread 2 is more firmly installed on the hub 1.

Much further, in order to better position and install the tread 2, as an implementation mode, the hub motor can also include a bottom cover 3 disposed at a lateral end of the hub 1; the tread 2 positioned at a lateral end of the bottom cover 3 is provided with an annular block piece; after the tread 2 is sleeved on the hub 1, the bottom cover 3 is fixedly connected to a lateral end of the hub 1 and holds the block piece of the tread 2 to prevent the tread 2 from sliding axially.

In an embodiment, as an implementation mode, the bottom cover 3 is fixedly connected to the lateral end of the hub 1 through screws 4, and the bottom cover 3 and the lateral end of the hub 1 are correspondingly formed with mounting holes of the screws 4.

The hub motor of the utility model can be applied to various products, such as four-wheel electric scooters and other sports and fitness articles.

Compared with the structures of the traditional hub motors, the hub motor of the utility model features that, the hub 1 and the tread 2 of the hub motor are disposed in a separate way; a plurality of positioning ribs 5 are axially disposed on the outer surface of the hub 1; the grooves adapted to the shapes of the positioning ribs 5 are formed on the inner surface of the tread 2; the positioning ribs 5 are clamped in the grooves; the tread 2 and the hub 1 are respectively radially convex and concave structures to prevent the tread 2 from falling off radially. In this way, the tread 2 of the hub motor provided by the utility model can be replaced; the installation structure is simple and firm, and the consumption and cost are greatly reduced.

The above are only some embodiments of the utility model and should not be regarded as limit to the utility model. Any equivalent structure or equivalent flow modifications made on the basis of the description of the utility model, or director or indirect application to other related fields, should fall within the protective scope of the utility model.

1. A hub motor, comprising:
a hub;
an annular tread sleeved on the hub, wherein the annular tread is fixedly connected to the hub;
a plurality of positioning ribs axially disposed on an outer surface of the hub; and
a plurality of grooves adapted to shapes of the positioning ribs, wherein the grooves are formed on the inner surface of the tread, and the positioning ribs are clamped in the grooves.

2. The hub motor according to claim 1, wherein cross sections of the positioning ribs are sector-shaped to prevent the tread from sliding radially, and a length of an end of each one of the sector-shaped positioning ribs that is away from the hub is greater than a length of an end of each one of the sector-shaped positioning ribs that is close to the hub.

3. The hub motor according to claim 2, wherein the positioning ribs have draft angles.

4. The hub motor according to claim 1, further comprising a bottom cover disposed at a lateral end of the hub, wherein the tread positioned at a lateral end of the bottom cover is provided with an annular block piece, and after the tread is sleeved on the hub, the bottom cover is fixedly connected to a lateral end of the hub and holds the block piece of the tread to prevent the tread from sliding axially.

5. The hub motor according to claim 4, wherein the bottom cover is fixedly connected to the lateral end of the hub through screws, and the bottom cover and the lateral end of the hub are correspondingly formed with mounting holes of screws.

6. The hub motor according to claim 2, further comprising a bottom cover disposed at a lateral end of the hub, wherein the tread positioned at a lateral end of the bottom cover is provided with an annular block piece, and after the tread is sleeved on the hub, the bottom cover is fixedly connected to a lateral end of the hub and holds the block piece of the tread to prevent the tread from sliding axially.

7. The hub motor according to claim 3, further comprising a bottom cover disposed at a lateral end of the hub, wherein the tread positioned at a lateral end of the bottom cover is provided with an annular block piece, and after the tread is sleeved on the hub, the bottom cover is fixedly connected to a lateral end of the hub and holds the block piece of the tread to prevent the tread from sliding axially.
